(19) United States
(12) Patent Application Publication
(10) Pub. No.: US 2004/0110637 A1
(43) Pub. Date: Jun. 10, 2004

(54) Method of safening crops using isoxazoline carboxylates

(76) Inventors: Frank Ziemer, Kriftel (DE); Christhoper Rosinger, Hofheim (DE); Erwin Hacker, Hochheim (DE); Hermann Bieringer, Eppstein (DE); Lothar Willms, Hofheim (DE)

Correspondence Address: William F Lawrence, Frommer Lawrence & Haug, 745 Fifth Avenue, New York, NY, 10151, US

(21) Appl. No.: 10/470,410

(22) PCT Filed: Jan. 31, 2002
(86) PCT No.: PCT/EP02/01003

(30) Foreign Application Priority Data
Jan. 31, 2001 (EP) 01102202.7

(51) Int. Cl. A01N 25/26; A01N 25/32

(52) U.S. Cl. 504/100; 504/106

(57) ABSTRACT

Method of protecting crop plants from phytotoxic side-effects of pesticides which comprises applying to the seed of a crop plant prior to sowing an effective amount of a compound of the formula (I) or a salt thereof, in which R¹ is phenyl which is unsubstituted or substituted, R² is (C₁-C₆) alkyl, (C₃-C₆) cyclalkyl or phenyl, each of the 3 last-mentioned radicals is unsubstituted or substituted, R³ is hydrogen or a hydrocarbon radical having 1 to 18 C-atoms which is unsubstituted or substituted. The safener of formula (I) is preferably isoxadifen or isoxadifen-ethyl. The seed treated crop plants are safened against the application of pesticides, particularly herbicides applied pre- or postemergent to the cultivation area.

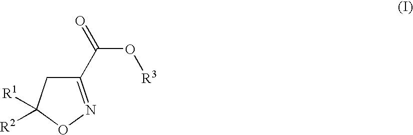

The present invention relates to the safening of crop plants against damage of pesticidal compounds occurring while using the pesticides for controlling undesired organisms in crops or useful plants including ornamental plants. The invention more particularly relates to the use of 5,5-diphenyl-2-isoxazoline-3-carboxylic acid derivatives as seed treatment safeners for different pesticides.

U.S. Pat. No. 5,516,750 describes the use of substituted isoxazolines as safeners for different classes of pesticides, especially for post-emergent (tankmix) application of a safener-herbicide combination to the area under cultivation. The use as seed treatment safeners has not been exemplified. It is further known from DE-A-19853827 (WO-A-00/30447) that isoxazoline safeners are specifically useful for safening crops from damage of various herbicides from the group of p-hydroxyphenyl pyruvate dioxygenase inhibitors (HPPDO inhibitors) such as sulcotrione, mesotrione or isoxaflutole, wherein the safener in the disclosed examples is applied pre- or post-emergence together with the herbicide.

Surprisingly, it has now been found that compounds from the group of 2-isoxazoline-3-carboxylic acid derivatives of the formula (I) below can be used very effectively as a seed treatment safener for pesticides, in particular herbicides.

The invention thus relates to a method of protecting crop plants from phytotoxic side-effects of pesticides which comprises applying to the propagation material, preferrably the seed, of a crop plant prior to sowing an effective amount of a compound of the formula (I) or a salt thereof,

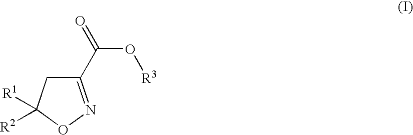

in which

R¹ is phenyl which is unsubstituted or substituted, preferably unsubstituted or substituted by one or more radicals selected from the group consisting of halogen, cyano, nitro, amino, (C₁-C₄)haloalkyl, (C₁-C₄)haloalkoxy, (C₁-C₄)alkyl, (C₁-C₄)alkoxy, mono(C₁-C₄)alkyl-amino, di(C₁-C₄)alkyl-amino, (C₁-C₄)alkylthio and/or (C₁-C₄)alkylsulfonyl,

R² is (C₁-C₆)alkyl, (C₃-C₆)cycloalkyl or phenyl, each of the 3 last-mentioned radicals is unsubstituted or substituted, preferably unsubstituted or substituted by one or more radicals selected from the group consisting of halogen, cyano, nitro, amino, (C₁-C₄)haloalkyl, (C₁-C₄)haloalkoxy, (C₁-C₄)alkyl, (C₁-C₄)alkoxy, mono(C₁-C₄)alkyl-amino, di(C₁-C₄)alkyl-amino, (C₁-C₄)alkylthio and/or (C₁-C₄)alkylsulfonyl,

R³ is hydrogen or a hydrocarbon radical having 1 to 18 C-atoms which is unsubstituted or substituted, preferably unsubstituted or substituted by one or more radicals selected from the group consisting of halogen, cyano, thio, nitro, hydroxyl, (C₁-C₆)alkyl, (C₁-C₆)haloalkyl, the 2 last-mentioned radicals as substituents of cyclic radicals only, (C₁-C₆)alkoxy, (C₂-C₆)alkenyloxy, (C₂-C₆)alkinyloxy, (C₁-C₆)haloalkoxy, (C₂-C₆)alkylthio, (C₃-C₆)cycloalkyl, (C₃-C₆)cycloalkoxy, (C₁-C₈)alkoxy-carbonyl, (C₂-C₆)alkenyloxy-carbonyl, (C₂-C₆)alkinyloxy-carbonyl, (C₁-C₈)alkyl-carbonyl, (C₁-C₆)alkyl-carbonyloxy, phenyl, phenyl-(C₁-C₆)alkoxy, phenyl-(C₁-C₆)alkoxy-carbonyl, phenoxy, phenoxy-(C₁-C₆)alkoxy, phenoxy-(C₁-C₆)alkoxy-carbonyl, phenoxycarbonyl, phenylcarbonyloxy and phenyl-(C₁-C₆)alkyl-carbonyloxy,

wherein the 9 last-mentioned radicals are unsubstituted or substituted in the phenyl ring, preferably unsubstituted or substituted by one or more radicals selected from the group consisting of halogen, (C₁-C₄)alkyl, (C₁-C₄)alkoxy, (C₁-C₄)haloalkyl, (C₁-C₄)haloalkoxy and nitro,

and radicals of the formula —O—N═CR′₂, —N═CR′₂,

wherein the R′ in the formulae independently of one another are hydrogen, (C₁-C₄)alkyl or phenyl, which is unsubstituted or substituted by one or more radicals selected from the group consisting of halogen, (C₁-C₄)alkyl, (C₁-C₄)alkoxy, (C₁-C₄)haloalkyl, (C₁-C₄)haloalkoxy and nitro, or together are a (C₂-C₆)alkylene chain.

The terms mentioned hereinabove and hereinbelow have the meanings outlined below:

A “hydrocarbon radical” is a straight-chain, branched or cyclic hydrocarbon radical which may be saturated, partially saturated, unsaturated or aromatic, for example alkyl, alkenyl, alkynyl, cycloalkyl, cycloalkenyl and aryl, preferably alkyl, alkenyl and alkynyl having up to 18 carbon atoms, preferably 12 carbon atoms, particularly 6 C-atoms, or cycloalkyl having 3 to 6 ring atoms or phenyl.

In the cases where two or more radicals are selected from a group of radicals as substituents at the same basic radical these radicals may be identical or different.

The term “halogen” includes fluorine, chlorine, bromine and iodine.

The term “(C₁-C₄)alkyl” is to be understood as a straight-chain or branched hydrocarbon radical having 1, 2, 3 or 4 carbon atoms, for example the methyl, ethyl, propyl, isopropyl, 1-butyl, 2-butyl, 2-methylpropyl or tert-butyl radical. Correspondingly, alkyl radicals having a greater range of carbon atoms are to be understood as straight-chain or branched saturated hydrocarbon radicals which contain a number of carbon atoms which corresponds to this range. The term “(C₁-C₆)alkyl” thus includes the abovementioned alkyl radicals, and also, for example, the pentyl, 2-methylbutyl, 1,1-dimethylpropyl and hexyl radical. In alkyl radicals or moieties throughout the definitions of radicals and composite radicals the number of carbon atoms is preferably from 1 to 4 unless otherwise defined more narrowly.

“(C₁-C₄)haloalkyl” is to be understood as an alkyl group mentioned under the term “(C₁-C₄)alkyl” in which one or more hydrogen atoms are replaced by the corresponding number of identical or different halogen atoms, preferably chlorine or fluorine, such as the trifluoromethyl, the 1-fluoroethyl, the 2,2,2-trifluoroethyl, the chloromethyl, fluoromethyl, the difluoromethyl and the 1,1,2,2-tetrafluoroethyl group.

“(C₁-C₄)alkoxy” is to be understood as an alkoxy group whose hydrocarbon radical has the meaning given under the term “(C₁-C₄)alkyl”. Alkoxy groups embracing a larger range of carbon atoms are to be understood likewise.

The terms “alkenyl” and “alkynyl” having a prefix stating a range of carbon atoms denote a straight-chain or branched hydrocarbon radical having a number of carbon atoms corresponding to this range, this hydrocarbon radical having at least one multiple bond which can be in any position of the unsaturated radical in question. “(C₂-C₆)alkenyl” thus denotes, for example, the vinyl, allyl, 2-methyl-2-propenyl, 2-butenyl, pentenyl, 2-methylpentenyl or the hexenyl group. “(C₂-C₆)-alkynyl” denotes, for example, the ethinyl, propargyl, 2-methyl-2-propinyl, 2-butinyl, 2-pentinyl or the 2-hexinyl group.

“(C₃-C₆)cycloalkyl” denotes monocyclic alkyl radicals, such as the cyclopropyl, cyclobutyl, cyclopentyl or cyclohexyl radical.

Other composite terms, such as (C₁-C₆)alkylthio, (C₁-C₆)alkylsulfonyl (C₃-C₆)cycloalkenyl or [(C₁-C₆)alkoxy]carbonyl are to be understood correspondingly, in accordance with the above definitions.

It will be understood that the use of salts of the safeners of formula (I), preferably salts formed by compounds when R³ is hydrogen, is also embraced by the invention.

The compounds of the formula (I) can form salts. Salt formation may occur by action of a base on those compounds of the formula (I) which carry an acidic hydrogen atom, for example those compounds (I) in which R³ is hydrogen. Suitable bases are, for example, organic amines and also ammonium, alkali metal or alkaline earth metal hydroxides, carbonates and bicarbonates, in particular sodium hydroxide and potassium hydroxide, sodium carbonate and potassium carbonate and sodium bicarbonate and potassium bicarbonate. Salt formation can also occur by addition of an acid to basic groups, such as amino and alkylamino. Acids which are suitable for this purpose are inorganic and organic acids, for example HCl, HBr, H₂SO₄, HNO₃ and acetic acid.

Of particular interest are safener compounds of said formula (I) or salts thereof in which R¹ and R² both are phenyl.

Of particular interest are also safener compounds of said formula (I) or salts thereof in which R³ is hydrogen or (C₁-C₆)alkyl which is unsubstituted or substituted by one or more radicals selected from the group consisting of halogen, cyano, (C₁-C₄)alkoxy, (C₂-C₄)alkenyloxy, (C₂-C₄)alkinyloxy, (C₁-C₄)haloalkoxy, (C₂-C₄)alkylthio, (C₃-C₆)cycloalkyl, (C₃-C₆)cycloalkoxy, (C₁-C₄)alkoxy-carbonyl, (C₂-C₄)alkenyloxy-carbonyl, (C₂-C₄)alkinyloxy-carbonyl, (C₁-C₄)alkyl-carbonyl, (C₁-C₄)alkyl-carbonyloxy and phenyl which is unsubstituted or substituted in the phenyl ring by one or more radicals selected from the group consisting of halogen, (C₁-C₄)alkyl, (C₁-C₄)alkoxy, (C₁-C₄)haloalkyl and (C₁-C₄)haloalkoxy. Preferred are compounds (I) in which R³ is H or (C₁-C₄)alkyl, specifically hydrogen, methyl or ethyl. Preferred are also salts formed from compounds (I) where R³ is hydrogen.

Preferably the safener of formula (I) is 5,5-diphenyl-2-isoxazoline-3-carboxylic acid (Ia) or ethyl 5,5-diphenyl-2-isoxazoline-3-carboxylate (Ib) (known under the common name isoxadifen or isoxadifen-ethyl, respectively); 2-isoxazoline means that the double bond is between the N-atom in 2-position and the C-atom in 3-position of the ring.

The safeners are applied to the propagation material of the crops prior to sowing. The propagation material can be the generative or vegetative propagation material or seedlings. Preferred is the treatment of the seeds of a crop. The safeners surprisingly reduce phytotoxic effects of pesticides to the propagation material, seeds, germinated crops of useful plants or to the already emerged crops of useful plants substantially. The extent of safening effect is surprising for the reason that the known methods comprise the application of the safener together with the pesticide in post-emergence application or, simultaneously or within a short period of time in a sequential manner, in pre-emergence application. The specific in-furrow treatment method comprises soil application before or after emergence of the crop with the safener followed shortly by the application of the pesticide. Because of said known techniques the effect of the seed treatment carried out with safeners of formula (I) substantially prior to the treatment of the pesticide was expected to be the far less effective safening variant. Reasons for the expectation are:

1. the relatively small amount of safener applicable to the propagation material or seed, which amount is further diluted in the emerging plant;

2. possible instability of the safener (degradation) in the propagation material prior to sowing and during emergence of the plant prior to the application of the pesticide;

3. possible damaging effect of the safener on the germination quality of the propagation material e. g. seed.

The experiments have shown, however, that the safener treatment of the propagation material, e. g. seeds, prior to sowing provides an effective safening which surprisingly is an alternative to the known methods and in some cases even far superior in effect. Apart from the safening effect the seed treatment has the advantage that, compared with the normal combination treatment, the farmer need not to apply two active ingredients but the pesticide only. This avoids a tank-mixing step and reduces the amount of active ingredients to be applied by the farmer as well as reducing the amount of formulation auxiliaries needed therefor.

The method of pre-treatment of crop seeds or other propagation material (such as a tuber of a potato) according to the invention can be used for safening the crop plants against phytotoxicity of a broad range of pesticides. The safeners of formula (I) and salts thereof (above and in the following also shortly together “safeners (I)” or “safeners of formula (I)”) are capable of reducing or eliminating altogether harmful side effects of these pesticides in crop plants, without adversely affecting the efficacy of these pesticides against undesirable harmful organisms. Damage which is caused by using a plurality of pesticides, for example by a plurality of herbicides or by herbicides in combination with insecticides or fungicides, can be reduced significantly or eliminated altogether. Thus, the area of application of conventional pesticides can be widened very considerably. Insecticides which, on their own or together with herbicides, can cause damage to plants include, for example: organophosphates, for example terbufos (Counter®), fonofos (Dyfonate®), phorate (Thimet®), chlorpyriphos (Reldan®), carbamates, such as carbofuran (Furadan®), pyrethroid insecticides, such as tefluthrin (Force®), deltamethrin (Decis®) and tralomethrin (Scout®) and other insecticidal agents having a different mechanism of action.

Herbicides whose phytotoxic side effects on crop plants can be reduced using compounds of the formula I are, for example, herbicides from the group of the carbamates, thiocarbamates, haloacetanilides, substituted phenoxy-, naphthoxy- and phenoxyphenoxy carboxylic acid derivatives and heteroaryloxyphenoxyalkane carboxylic acid derivatives, such as quinolyloxy-, quinoxalyloxy-, pyridyloxy-, benzoxazolyloxy- and benzothiazolyloxyphenoxyalkane carboxylic acid esters, cyclohexanedione derivatives, imidazolinones, pyrimidinyloxypyridincarboxylic acid derivatives, pyrimidyloxybenzoic acid derivatives, sulfonylureas, triazolopyrimidinesulfonamide derivatives and S-(N-aryl-N-alkylcarbamoylmethyl)dithiophosphoric esters, hormone-type herbicides, pyridinecarboxylic acids, triazinones, triazolinones, pyridinecarboxamides, hydroxybenzonitriles, isoxazoles. Preference is given to phenoxyphenoxy- and heteroaryloxyphenoxy carboxylic acid esters and salts, sulfonylureas, imidazolinones, isoxazoles and herbicides which, together with ALS inhibitors (acetolactate synthetase inhibitors), are employed for widening the activity spectrum, for example bentazone, cyanazin, atrazin, bromoxynil, dicamba and other leaf-acting herbicides.

Herbicides which are suitable for combination with the safeners according to the invention include, for example:

A) herbicides of the type of the phenoxyphenoxy- and heteroaryloxyphenoxycarboxylic acid derivatives, such as

A1) phenoxyphenoxy- and benzyloxyphenoxycarboxylic acid derivatives, for example methyl 2-(4-(2,4-dichlorophenoxy)phenoxy)propionate (diclofop-methyl), methyl 2-(4-(4-bromo-2-chlorophenoxy)phenoxy)propionate (DE-A 26 01 548), methyl 2-(4-(4-bromo-2-fluorophenoxy)phenoxy)propionate (U.S. Pat. No. 4,808,750), methyl 2-(4-(2-chloro4-trifluoromethylphenoxy)phenoxy)propionate (DE-A 24 33 067), methyl 2-(4-(2-fluoro4-trifluoromethylphenoxy)phenoxy)propionate (U.S. Pat. No. 4,808,750), methyl 2-(4-(2,4-dichlorobenzyl)phenoxy)propionate (DE-A 24 17 487), ethyl 4-(4-(4-trifluoromethylphenoxy)phenoxy)pent-2-enoate, methyl 2-(4-(4-trifluoromethylphenoxy)phenoxy)propionate (DE-A 24 33 067);

A2) “mononuclear” heteroaryloxyphenoxyalkanecarboxylic acid derivatives, for example

ethyl 2-(4-(3,5-dichloropyridyl-2-oxy)phenoxy)propionate (EP-A 0 002 925),

propargyl 2-(4-(3,5-dichloropyridyl-2-oxy)phenoxy)propionate (EP-A 0 003 114),

methyl 2-(4-(3-chloro-5-trifluoromethyl-2-pyridyloxy)phenoxy)propionate-methylester (EP-A 0 003 890),

ethyl 2-(4-(3-chloro-5-trifluoromethyl-2-pyridyloxy)phenoxy)propionate (EP-A 0 003 890),

propargyl 2-(4-(5-chloro-3-fluoro-2-pyridyloxy)phenoxy)propionate (EP-A 0 191 736),

butyl 2-(4-(5-trifluoromethyl-2-pyridyloxy)phenoxy)propionate (Fluazifop-butyl);

A3) “dinuclear” heteroaryloxyphenoxyalkanecarboxylic acid derivatives, for example

methyl and ethyl 2-(4-(6-chloro-2-quinoxalyloxy)phenoxy)propionate (quizalofop-methyl and quizalofop-ethyl),

methyl 2-(4-(6-fluoro-2-quinoxalyloxy)phenoxy)propionate (see J. Pest. Sci. Vol.10, 61 (1985)),

2-isopropylideneaminooxyethyl 2-(4-(6-chloro-2-quinoxalyloxy)phenoxy)propionate (propaquizafop),

ethyl 2-(4-(6-chlorobenzoxazol-2-yl-oxy)phenoxy)propionate (fenoxaprop-ethyl), its D(+) isomer (fenoxaprop-P-ethyl) and ethyl 2-(4-(6-chlorobenzothiazol-2-yloxy)phenoxy)propionate (DE-A 26 40 730),

tetrahydro-2-furylmethyl 2-(4(6-chloroquinoxalyloxy)phenoxy)propionate (EP-A 0 323 727);

B) herbicides from the group of the sulfonylureas, such as pyrimidine- or triazinylaminocarbonyl-[benzene-, pyridine-, pyrazol-, thiophen- and (alkylsulfonyl)alkylamino-]sulfamides. Preferred substituents at the pyrimidine ring or the triazine ring are alkoxy, alkyl, haloalkoxy, haloalkyl, halogen or dimethylamino, and it is possible to combine all substituents independently of one another. Preferred substituents in the benzene, pyridine, pyrazol, thiophene or (alkylsulfonyl)alkylamino moiety are alkyl, alkoxy, halogen, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, (alkanesulfonyl)alkylamino. Such suitable sulfonylureas are, for example,

B1) phenyl- and benzylsulfonylureas and related compounds, for example

1-(2-chlorophenylsulfonyl)-3-(4-methoxy-6-methyl-1,3,5-triazin-2-yl)urea (chlorsulfuron),

1-(2-ethoxycarbonylphenysulfonyl)-3-(4-chloro-6-methoxypyrimidin-2-yl)urea (chlorimuron-ethyl),

1-(2-methoxyphenylsulfonyl)-3-(4-methoxy-6-methyl-1,3,5-triazin-2-yl)urea (metsulfuron-methyl),

1-(2-chloroethoxyphenylsulfonyl)-3-(4-methoxy-6-methyl-1,3,5-triazin-2-yl)urea (triasulfuron),

1-(2-methoxycarbonylphenylsulfonyl)-3-(4,6-dimethylpyrimidin-2-yl)urea (sulfometuron-methyl),

1-(2-methoxycarbonylphenylsulfonyl)-3-(4-methoxy-6-methyl-1,3,5-triazin-2-yl)-3-methylurea (tribenuron-methyl),

1-(2-methoxycarbonylbenzylsulfonyl)-3-(4,6-dimethoxypyrimidin-2-yl)urea (bensulfuron-methyl),

1-(2-methoxycarbonylphenylsulfonyl)-3-(4,6-bis-(difluoromethoxy)pyrimidin-2-yl)urea, (primisulfuron-methyl),

3-(4-ethyl-6-methoxy-1,3,5-triazin-2-yl)-1 -(2,3-dihydro-1,1-dioxo-2-methylbenzo[b]thiophen-7-sulfonyl)urea (EP-A 0 796 83),

3-(4-ethoxy-6-ethyl-1,3,5-triazin-2-yl)-1-(2,3-dihydro-1,1-dioxo-2-methylbenzo[b]thiophen-7-sulfonyl)urea (EP-A 0 079 683),

3-(4-methoxy-6-methyl-1,3,5-triazin-2-yl)-1-(2-methoxycarbonyl-5-iodophenylsulfonyl)urea (iodosulfuron-methyl) (WO 92/13845),

DPX-66037, triflusulfuron-methyl (see Brighton Crop Prot. Conf.—Weeds—1995, p. 853),

CGA-277476, (see Brighton Crop Prot. Conf.—Weeds—1995, p. 79),

Methyl-2-[3-(4,6-dimethoxypyrimidin-2-yl)ureidosulfonyl]-4-methanesulfonamidomethylbenzoate (mesosulfuron-methyl) (WO 95/10507),

N,N-dimethyl-2-[3-(4,6-dimethoxypyrimidin-2-yl)ureidosulfonyl]-4-formylaminobenzamide (foramsulfuron) (WO 95/01344);

B2) thienylsulfonylureas, for example

1-(2-methoxycarbonylthiophen-3-yl)-3-(4-methoxy-6-methyl-1,3,5-triazin-2-yl)urea (thifensulfuron-methyl);

B3) pyrazolylsulfonylureas, for example

1-(4-ethoxycarbonyl-1-methylpyrazol-5-ylsulfonyl)-3-(4,6-dimethoxypyrimidin-2-yl)urea (pyrazosulfuron-methyl);

methyl 3-chloro-5-(4,6-dimethoxypyrimidin-2-ylcarbamoylsulfamoyl)-1-methylpyrazol-4-carboxylate (EP-A 0 282 613);

methyl 5-(4,6-dimethylpyrimidin-2-ylcarbamoylsulfamoyl)-1-(2-pyridyl)pyrazol-4-carboxylate (NC-330, see Brighton Crop Prot. Conference ‘Weeds’ 1991, Vol.1, p. 45ff.),

DPX-A8947, azimsulfuron, (see Brighton Crop Prot. Conf. ‘Weeds’ 1995, p. 65);

B4) sulfonediamide derivatives, for example

3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, special issue XII, 489-497 (1990));

B5) pyridylsulfonylureas, for example

1-(3-N,N-dimethylaminocarbonylpyridin-2-ysulfonyl)-3-(4,6-dimethoxypyrimidin-2-yl)urea (nicosulfuron),

1-(3-ethylsulfonylpyridin-2-ysulfonyl)-3-(4,6-dimethoxypyrimidin-2-yl)urea (rimsulfuron),

methyl 2-[3-(4,6-dimethoxypyrimidin-2-yl)ureidosulfonyl]-6-trifluoromethyl-3-pyridincarboxylate, sodium salt (DPX-KE 459, flupyrsulfuron, see Brighton Crop Prot. Conf. Weeds, 1995, p. 49),

pyridylsulfonylureas, as described in DE-A 40 00 503 and DE-A 40 30 577, preferably those of the formula

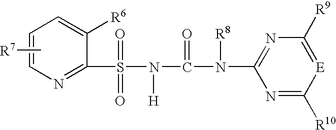

in which

E is CH or N, preferably CH,

R⁶ is iodine or NR¹¹R¹²,

R⁷ is hydrogen, halogen, cyano, (C₁-C₃)-alkyl, (C₁-C₃)-alkoxy, (C₁-C₃)-haloalkyl, (C₁-C₃)-haloalkoxy, (C₁-C₃)-alkylthio, (C₁-C₃)-alkoxy-(C₁-C₃)-alkyl, (C₁-C₃)-alkoxycarbonyl, mono- or di-((C₁-C₃)-alkyl)amino, (C₁-C₃)-alkylsulfinyl or -sulfonyl, SO₂—NR^{a}R^{b} or CO—NR^{a}R^{b}, in particular hydrogen,

R^{a} and R^{b} independently of one another are hydrogen, (C₁-C₃)-alkyl, (C₁-C₃)-alkenyl, (C₁-C₃)-alkynyl or together are —(CH₂)₄—, —(CH₂)₅— or —(CH₂)₂—O—(CH₂)₂—,

R⁸ is hydrogen or CH₃,

R⁹ is halogen, (C₁-C₂)-alkyl, (C₁-C₂)-alkoxy, (C₁-C₂)-haloalkyl, in particular CF₃, (C₁-C₂)-haloalkoxy, preferably OCHF₂ or OCH₂CF₃,

R¹⁰ is (C₁-C₂)-alkyl, (C₁-C₂)-haloalkoxy, preferably OCHF₂, or (C₁-C₂)-alkoxy, and

R¹¹ is (C₁-C₄)-alkyl and

R¹² is (C₁-C₄)-alkylsulfonyl or

R¹¹ and R¹² together are a chain of the formula —(CH₂)₃SO₂— or —(CH₂)₄SO₂—, for example 3-(4,6-dimethoxypyrimiden-2-yl)-1-(3-N-methylsulfonyl-N-methylaminopyridin-2-yl)sulfonylurea, or salts thereof;

B6) alkoxyphenoxysulfonylureas as described in EP-A 0 342 569, preferably those of the formula

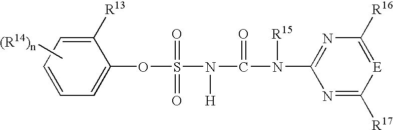

in which

E is CH or N, preferably CH,

R¹³ is ethoxy, propoxy or isopropoxy,

R¹⁴ is hydrogen, halogen, NO₂, CF₃, CN, (C₁-C₄)-alkyl, (C₁-C₄)-alkoxy, (C₁-C₄)-alkylthio or (C₁-C₃)-alkoxy)carbonyl, preferably in position 6 on the phenyl ring,

n is 1, 2 or 3, preferably 1,

R¹⁵ is hydrogen, (C₁-C₄)-alkyl or (C₃-C₄)-alkenyl,

R¹⁶, R¹⁷independently of one another are halogen, (C₁-C₂)-alkyl, (C₁-C₂)-alkoxy, (C₁-C₂)-haloalkyl, (C₁-C₂)-haloalkoxy or (C₁-C₂)-alkoxy-(C₁-C₂)-alkyl, preferably OCH₃ or CH₃, for example 3-(4,6-dimethoxypyrimidin-2-yl)-1-(2-ethoxyphenoxy)sulfonylurea, or salts thereof;

B7) imidazolylsulfonylureas, for example

MON 37500, sulfosulfuron (see Brighton Crop Prot. Conf. ‘Weeds’, 1995, p: 57), and other related sulfonylurea derivatives and mixtures thereof;

C) chloroacetanilides, for example

N-methoxymethyl-2,6-diethylchloroacetanilide (alachlor),

N-(3-methoxyprop-2-yl)-2-methyl-6-ethylchloroacetanilide (metolachlor),

2-chloro-N-(2-ethyl-6-methylphenyl)-N-[(1S)-2-methoxy-1-methylethyl)]-acetamide (S-metolachlor),

2,6-dimethyl-N-(3-methyl-1,2,4-oxadiazol-5-ylmethyl)chloroacetanilide,

N-(2,6-dimethylphenyl)-N-(1-pyrazolylmethyl)chloroacetamide (metazachlor);

(RS)-2-chloro-N-(2,4-diethyl-3-thienyl)-N-(2-methoxy-1-methylethyl)acetamide (dimethenamide),

(S)-2-chloro-N-(2,4-diethyl-3-thienyl)-N-(2-methoxy-1-methylethyl)acetamide (dimethenamide-P),

4′-fluoro-N-isopropyl-2-[5-trifluoromethyl-1,3,4-thiadiazol-2-yloxy]acetanilide (flufenacet),

D) thiocarbamates, for example

S-ethyl-N,N-dipropylthiocarbamate (EPTC),

S-ethyl-N,N-diisobutylthiocarbamate (butylate);

E) cyclohexanedione oximes, for example

methyl 3-(1-allyloxyiminobutyl)-4-hydroxy-6,6-dimethyl-2-oxocyclohex-3-enecarboxylate (alloxydim),

2-(1-ethoxyiminobutyl)-5-(2-ethylthiopropyl)-3-hydroxycyclohex-2-en-1-one (sethoxydim),

2-(1-ethoxyiminobutyl)-5-(2-phenylthiopropyl)3-hydroxycyclohex-2-en-1-one (cloproxydim),

2-(1-(3-chloroallyloxy)iminobutyl)-5-(2-ethylthiopropyl)-3-hydroxycyclohex-2-en-1-one,

2-(1-(3-chloroallyloxy)iminopropyl)-5-(2-ethylthiopropyl)-3-hydroxycyclohex-2-en-1-one (clethodim),

2-(1-ethoxyiminobutyl)-3-hydroxy-5-(thian-3-yl)-cyclohex-2-enone (cycloxydim),

2-(1-ethoxyiminopropyl)-5-(2,4,6-trimethylphenyl)-3-hydroxycyclohex-2-en-1-one (tralkoxydim);

F) imidazolinones, for example

methyl 2-(4-isopropyl-4-methyl-5-oxo-2-imidazolin-2-yl)-5-methylbenzoate and

2-(4-isopropyl-4-methyl-5-oxo-2-imidazolin-2-yl)-4-methylbenzoic acid (imazamethabenz),

5-ethyl-2-(4-isopropyl-4-methyl-5-oxo-2-imidazolin-2-yl)pyridin-3-carboxylic acid (imazethapyr),

2-(4-isopropyl-4-methyl-5-oxo-2-imidazolin-2-yl)quinolin-3-carboxylic acid (imazaquin),

2-(4-isopropyl-4-methyl-5-oxo-2-imidazolin-2-yl)-pyridin-3-carboxylic acid (imazapyr),

5-methyl-2-(4-isopropyl4-methyl-5-oxo-2-imidazolin-2-yl)pyridin-3-carboxylic acid (imazethamethapyr);

G) triazolopyrimidinsulfonamide derivatives, for example

N-(2,6-difluorophenyl)-7-methyl-1,2,4-triazolo[1,5-c]pyrimidin-2-sulfonamide (flumetsulam),

N-(2,6-dichloro-3-methylphenyl5,7-dimethoxy-1,2,4-triazolo[1,5-c]pyrimidin-2-sulfonamide,

N-(2,6-difluorophenyl)-8-fluoro-5-methoxy-1,2,4-triazolo[1,5-c]pyrimidin-2-sulfonamide (florasulam),

N-(2,6-dichloro-3-methylphenyl)-7-chloro-5-methoxy-1,2,4-triazolo[1,5-c]pyrimidin-2-sulfonamide,

N-(2-chloro-6-methoxycarbonyl)-5,7-dimethyl-1,2,4-triazolo[1,5-c]pyrimidin-2-sulfonamide (EP-A 0 343 752, U.S. Pat. No. 4,988,812);

methyl 3-chloro-(5-ethoxy-7-fluoro[1,2,4]triazole-[1,5-c]pyrimidin-2-ylsulfonamido)-benzoate (chloransulam);

H) benzoylcyclohexanediones, for example

2-(2-chloro-4-methylsulfonylbenzoyl)cyclohexane-1,3-dione (SC-0051, EP-A-0137963),

2-(2-nitrobenzoyl)-4,4-dimethylcyclohexane-1,3-dione (EP-A-0274634),

2-(2-nitro-3-methylsulfonylbenzoyl)-4,4-dimethylcyclohexane-1,3-dione (WO 91/13548);

2-nitro-4-mesylbenzoyl-cyclohexan-1,3-dione (mesotrione);

and other compounds known from EP-A-0496630, EP-A-0496631, EP-A-0625505 and EP-A-0625508;

I) pyrimidinyloxypyridinecarboxylic acid or pyrimidinyloxybenzoic acid derivatives, for example

benzyl 3-(4,6-dimethoxypyrimidin-2-yl)oxypyridin-2-carboxylate (EP-A 0 249 707),

methyl 3-(4,6-dimethoxypyrimidin-2-yl)oxypyridin-2-carboxylate (EP-A 0 249 707),

2,6-bis[(4,6-dimethoxypyrimidin-2-yl)oxy]benzoic acid (EP-A 0 321 846),

1-(ethoxycarbonyloxyethyl) 2,6-bis[(4,6-dimethoxypyrimidin-2-yl)oxy]benzoate (EP-A 0 472 113);

J) S-(N-aryl-N-alkylcarbamoylmethyl)dithiophosphonic acid esters, such as

S-[N-(4-chlorophenyl)-N-isopropylcarbamoylmethyl] O,O-dimethyl dithiophosphate (anilophos).

K) plant-hormone-type (auxine-type) herbicides, for example

3,6-dichloro-2-methoxy-benzoic acid and salts and esters (e. g. methyl ester) thereof; (dicamba)

2-{1-[4-(3,5-difluorophenyl)semicarbazono]ethyl}nicotinic acid and salts (e. g. sodium salt) thereof (diflufenzopyr);

3,5,6-trichloro-2-pyridyloxyacetic acid (triclopyr);

4-amino-3,5-dichloro-6-fluoro-2-pyridyloxyacetic acid and salts and esters thereof (fluroxypyr);

L) triazinones, for example

4-amino-6-tert-butyl4,5-dihydro-3-methylthio-1,2,4-triazin-5-one (metribuzin);

M) triazolinones, for example

ethyl (RS)-2-chloro-3-[2-chloro-5-(4-difluoromethyl-4,5-dihydro-3-methyl-5-oxo-1H-1,2,4-triazol-1-yl)-4-fluorophenyl]propionate (carfentrazone-ethyl)

N) pyridinecarboxamides, for example

N-(2,4-difluorophenyl)-2-[3-(trifluoromethyl)phenoxy]-3-pyridinecarboxamide (diflufenican)

O) hydroxybenzonitriles, for example

3,5-dibromo4-hydroxybenzonitrile and salts and esters thereof (bromoxynil);

4-hydroxy-3,5-di-iodobenzonitrile and salts and esters thereof (ioxynil);

P) herbicidal benzoylisoxazole derivatives, for example

5-cyclopropyl4-[2-chloro-3-ethoxy-4-(ethylsulphonyl)benzoyl]isoxazole;

4-(4-chloro-2-methylsulphonylbenzoyl)-5-cyclopropylisoxazole;

5-cyclopropyl-4-(2-methylsulphonyl-4-trifluoromethylbenzoyl)isoxazole (isoxaflutole);

4-(4-bromo-2-methylsulphonylbenzoyl)-5-cyclopropylisoxazole;

5-cyclopropyl-4-[4-fluoro-3-methoxy-2-(methylsulphonyl)benzoyl]isoxazole;

4-(4-bromo-2-methylsulphonylmethylbenzoyl)-5-cyclopropylisoxazole;

ethyl 5-cyclopropyl-4-(2-methylsulphonyl-4-trifluoromethylbenzoyl)isoxazole-3-carboxylate;

5-cyclopropyl-4-(2-methylsulphonyl-4-trifluoromethylbenzoyl)-3-methylthio-isoxazole;

and other herbicidal compounds known from EP-A-0418175, EP-A-0487357, EP-A-0527036 and EP-A-0560482;

the most preferred compounds are 5-cyclopropyl-4-(2-methylsulphonyl-4-trifluoromethylbenzoyl)isoxazole and 2[-2-nitro-(4-methylsulphonyl)benzoyl]-1,3-cyclohexanedione.

The herbicides of groups A to P are known, for example, from the above-mentioned publications and from “The Pesticide Manual”, The British Crop Protection Council and the Royal Soc. of Chemistry, 12th Edition, 2000, “Agricultural Chemicals Book II—Herbicides—”, by W. T. Thompson, Thompson Publications, Fresno Calif., USA 1990 and “Farm Chemicals Handbook '2000”, Meister Publishing Company, Willoughby Ohio, USA, 2000. Other compounds for use in this invention, such as the herbicidal benzoylisoxazole and/or dione compounds as far as not commercially available, may be prepared by the methods described in the aforementioned patent publications, or by the application or adaptation of known methods used or described in the chemical literature for similar compounds. In some cases the common names are mentioned in the herbicide list. In such case the common name identifies the active ingredient in its commercially available form or forms including derivatives such as salts and esters, even if a specific salt or ester is not mentioned specifically, preferably its usual commercial form.

The safeners of the formula I according to the invention have a particular advantage in combination with herbicides from the group of the isoxazoles, sulfonylureas, chloracetamides and/or imidazolinones and with herbicides of the type of the phenoxyphenoxy- and heteroaryloxyphenoxyalkanecarboxylic acid derivatives. This is because a large number of herbicides of these structural classes cause considerable damage to useful plants, in particular in crops of cereals, in maize and rice, and they can therefore not always be employed in these crops.

The application of the pesticides or particularly herbicides in the seed treated crops or like treated crops (in the following short “seed treated crop”) can be in pre- or post-emergence application. The seed treated crop plants can be further treated by a single pesticide or a pesticide combination including further safener treatment pre- or post-emergent. The preferred application method depends on the usual or optimal application time of the particular pesticide or pesticide combination. Some embodiments of the application method thus follow the scheme (abbreviation: ST=seed treatment, PE=pre-emergence application, PO=post-emergence application):

ST+PE (herbicide)

ST+PO (herbicide)

ST+PE (herbicide 1+herbicide 2)

ST+PO (herbicide 1+herbicide 2)

ST+PE (herbicide+safener)

ST+PO (herbicide+safener)

ST+PE (herbicide 1+herbicide 2+safener)

ST+PO (herbicide 1+herbicide 2+safener)

ST+PE (herbicide 1)+PO (herbicide 2)

ST+PE (herbicide 1+safener)+PO (herbicide 2)

ST+PE (herbicide 1)+PO (herbicide 2+safener)

ST+PE (herbicide 1+safener)+PO (herbicide 2+safener)

ST+PE (herbicide 1+safener 1)+PO (herbicide 2+safener 2)

ST+PE (herbicide 1)+PO (herbicide 2+herbicide 3+safener)

ST+PE (herbicide 1+safener)+PO (herbicide 2+herbicide 3+safener)

ST+PE (herbicide 1+safener)+PO (herbicide 1+safener)

Preferred examples for the invention method are:

1. Corn seed treatment with Safener (I), such as (Ia) or (Ib), defined above, followed by pre-emergence application of an isoxazole herbicide (see herbicide group P) such as isoxaflutole.

2. Corn seed treatment with Safener (I), such as (Ia) or (Ib), followed by pre-emergence application of an chloroacetanilide herbicide such as dimethenamide or dimethenamide-P (S-dimethenamide) or S-metolachlor or metolachlor.

3. Corn seed treatment with Safener (I), such as (Ia) or (Ib), followed by post-emergence application of an isoxazole herbicide such as isoxaflutole.

4. Corn seed treatment with Safener (I), such as (Ia) or (Ib), followed by post-emergence application of an sulfonylurea herbicide such as foramsulfuron, tribenuron, chlorimuron, rimsulfuron, thifensulfuron, tribenuron+thifensulfuron, metsulfuron, rimsulfuron+thifensulfuron, ethoxysulfuron, iodosulfuron-methyl, foramsulfuron+iodosulfuron-methyl, in each case optionally in the presence of additional safener.

5. Corn seed treatment with Safener (I), such as (Ia) or (Ib), followed by post-emergence application of an imidazolinone herbicide such as imazapyr.

6. Corn seed treatment with Safener (I), such as (Ia) or (Ib), followed by pre-emergence application of an chloroacetanilide herbicide, such as dimethenamide or dimethenamide-P.

7. Corn seed treatment with Safener (I), such as (Ia) or (Ib), followed by pre-emergence application of an isoxazole herbicide such as isoxaflutole followed by post-emergence treatment with a sulfonylurea herbicide such as foramsulfuron, tribenuron, chlorimuron, rimsulfuron, thifensulfuron, tribenuron+thifensulfuron, metsulfuron, rimsulfuron+thifensulfuron, ethoxysulfuron, iodosulfuron-methyl, foramsulfuron+iodosulfuron-methyl, in each case optionally in the presence of additional safener.

8. Corn seed treatment with Safener (I), such as (Ia) or (Ib), followed by pre-emergence application of an isoxazole herbicide-safener combination such as isoxaflutole+additional safener (Ia) or (Ib) followed by post-emergence treatment with a sulfonylurea herbicide-safener combination such as foramsulfuron+additional safener (Ia) or (Ib).

9. Corn seed treatment with Safener (I), such as (Ia) or (Ib), followed by post-emergence treatment with a plant hormone type herbicide, such as dicamba, diflufenzopyr, fluroxypyr or triclopyr or a combination of such herbicides, such as dicamba+diflufenzopyr, optionally in combination with additional safener (Ia) or (Ib).

10. Corn seed treatment with Safener (I), such as (Ia) or (Ib), followed by pre-emergence application of an isoxazole herbicide-safener combination such as isoxaflutole, followed by post-emergence treatment with a plant hormone type herbicide, such as dicamba, diflufenzopyr, fluroxypyr or triclopyr or a combination of such herbicides, such as dicamba+diflufenzopyr, optionally in combination with additional safener (Ia) or (Ib).

11. Corn seed treatment with Safener (I), such as (Ia) or (Ib), followed by post-emergence treatment with a triazolopyrimidine herbicide such as florasulam or chloransulam, optionally in combination with additional safener (Ia) or (Ib).

12. Corn seed treatment with Safener (I), such as (Ia) or (Ib), by pre-emergence application of an isoxazole herbicide-safener combination such as isoxaflutole, followed by post-emergence treatment with a triazolopyrimidine herbicide such as florasulam or chloransulam, optionally in combination with additional safener (Ia) or (Ib).

13. Wheat seed treatment with Safener (I), such as (Ia) or (Ib), followed by pre-emergence application of an chloroacetanilide herbicide such as dimethenamide or S-dimethenamide or S-metolachlor or metolachlor.

14. Barley seed treatment with Safener (I), such as (Ia) or (Ib), followed by pre-emergence application of an chloroacetanilide herbicide such as dimethenamide or S-dimethenamide or S-metolachlor or metolachlor.

According to the invention method the safener is applied to the seed before sowing (seed dressing) or to the propagation material likewise, which means that an effective quantity of crop seed is coated with the safener before seeding. The seed may also be treated, for example, short before sowing, for example by dipping the seeds into or mixing the seeds with a solution of the safener in an appropriate solvent. The pesticidal or preferably herbicidal compound may then by applied to the surface of the growing medium (for example pre-emergent) or by treatment of the crop after it has emerged from the soil.

The amount of antidote used in the method of the invention varies according to a number of parameters including the particular safener employed, the crop to be protected, the amount and rate of pesticide applied, the soil type and climatic conditions prevailing. Also, the selection of the specific safener for use in the method of the invention, the manner in which it is to be applied and the determination of the activity which is non-phytotoxic but antidotally effective, can be readily performed in accordance with common practice in the art. The application rate of safener can vary within wide limits and is for example from 0.01 to 10 grammes a. i. safener per kilogramme seed, preferably 0.05 to 1 g a. i. safener per kg seed, in particular 0.1 to 0.5 g a. i. safener per kilogramme seed, preferably corn seed.

If solutions of safeners are used in the seed treatment method wherein the seeds are soaked in the safener solution, the concentration of the safener in the solution is for example from 1 to 10000 ppm, preferably 100 to 1000 ppm based on weight.

The weight ratio of safener to pesticide can be varied within wide limits, and its optimum weight ratio depends both on the active compounds safener and pesticide employed and on the kind of useful plants to be protected. The required safener application rate, depending on the pesticide employed and the kind of useful plant to be protected, can be varied within the limits mentioned above for the ratio of safener per kg seed. The amounts and weight ratios required for a successful treatment can be determined by simple preliminary tests.

The antidote is applied in a non-phytotoxic antidotally effective amount. By “non-phytotoxic” is meant an amount of the antidote which causes at most minor or no injury to the desired crop species. By “antidotally-effective” is meant an antidote (safener) used in an amount which is effective as an antidote with the herbicide to decrease the extent of injury caused by the herbicide to the desired crop species.

The method of the invention may be used to obtain selective weed control with low crop injury in various crop plants such as maize, cereals such as wheat, barley and rye, oats, rice, soybean, cotton, canola, sugar beet, potatoes, tobacco, and oil seed rape. Preferred crops include maize, rice and cereals, sugar beet, cotton and canola. Particularly preferred crop species are maize, wheat, barley, rice, soybean and cotton Preferred crops of useful plants are cereals and maize, especially maize (corn).

The safener may also be used in crops of genetically engineered plants which are either known or still to be developed. As a rule, the transgenic plants are distinguished by particular, advantageous properties, for example by resistances to certain crop protection agents, resistances to plant diseases or pathogens causing plant diseases such as particular insects or microorganisms such as fungi, bacteria or viruses. Other particular properties relate for example, to the harvested material in terms of quantity, quality, storing properties, composition and specific constituents. Thus, transgenic plants are known which have an increased starch content or an altered starch quality, or those where the harvested material has a different fatty acid composition. The safeners may be used in economically important transgenic crops of useful plants and ornamentals, for example cereals such as wheat, barley, rye, oats, panic grasses, rice, cassava and corn or else crops of sugar beet, cotton, soya, oilseed rape, potatoes, tomatoes, peas and other types of vegetables.

Particularly preferred are maize (corn) varieties. Examples for possible corn varieties are:

CARGILL 1077, 814-46 (POPCORN), 8527 (WHITE), 8540LLI, 8540LLI, BECKS 5305, BECKS 5405, CARGILL 7050LL, CIBA 454, COUNTER, DEKALB 546, DEKALB 592SR, DEKALB 614, DEKALB 623, DEKALB 626, DEKALB 642, DEKALB 674, DEKALB 689, FORCE, G 8541, GC 8101, GC8101, GC8101, H013, H037, H131, H132, H139, H626, HLIB, HOLDEN 1205410, HOLDEN 1310112, HOLDEN 1310113, HOLDEN 1325001, HOLDEN 1325023, HOLDEN 1397528, HOLDEN LL, HOLDENS 1196637, HOLDENS 1205402, HOLDENS 1310113, HOLDENS LL 19962.18, HYPERFORMER 9843, ICI 8539, ICI 8541, ICI 8801, IL XTRA (SWEET), IXLXSWT, LIBERTY LINK, NORTHRUP KING 2555BT, NORTHRUP KING 3030BT, NORTHRUP KING 4218, NORTHRUP KING 4242, NORTHRUP KING 4242+CNTR, NORTHRUP KING 4242BT, NORTHRUP KING 4620, NORTHRUP KING 6800BT, NORTHRUP KING 7070, NORTHRUP KING 7639B, NORTHRUP KING 8811, P3394/COUNTER@12 oz, P3394/COUNTER@6 oz, P3394/FORCE, PIONEER 3049*, PIONEER 3082, PIONEER 3085, PIONEER 3140, PIONEER 3163, PIONEER 3165, PIONEER 3335, PIONEER 3394, PIONEER 3395IR, PIONEER 33A63, PIONEER 33G28, PIONEER 33K81, PIONEER 33Y11, PIONEER 3489, PIONEER 34A55, PIONEER 34A55LL, PIONEER 34B25, PIONEER 34P93, PIONEER 34T14, PIONEER 35N05, PIONEER 3677, PIONEER 3751, PIONEER 3751IR, PIONEER 37H97, PIONEER 37R71, PIONEER 3893, PIONEER 3897, PIONEER 38B22LL, PIONEER 3936, PIONEER 3941, PIONEER 3963, PIONEER 3984, TERRA 1167 and WYFFEL 794

The method of using safeners of the formula (I) have a particular advantage in combination with the application of pesticides which cause considerable damage to useful plants. The safeners of the formula I as well as the pesticides and particularly herbicides can be formulated in the usual manner various ways, depending on the prevailing chemical-physical and biological parameters. Examples of suitable formulations are:

emulsifiable concentrates which are prepared by dissolving the active compounds in an organic solvent, for example butanol, cyclohexanone, dimethylformamide, xylene or else higher-boiling hydrocarbons or mixtures of the organic solvents with addition of one or more ionic and/or nonionic surfactants (emulsifiers). Suitable emulsifiers are, for example, calcium alkylarylsulfonates, fatty acid polyglycol esters, alkylaryl polyglycol ethers, fatty alcohol polyglycol ethers, propylene oxide/ethylene oxide condensates, alkyl polyethers, sorbitan esters and polyoxyethylenesorbitan fatty acid esters

dusts, which are obtained by grinding the active compounds with finely dispersed solid inorganic or organic substances, for example talc, natural clays, such as kaolin, bentonite and pyrophyllite, diatomaceous earth or meals

water- or oil-based suspension concentrates, which can be prepared, for example, by wet grinding using bead mills

water-soluble powders

water-soluble concentrates

granules, such as water-soluble granules, water-dispersible granules and granules for application by broadcasting and soil application

wettable powders, which, in addition to active compound, also contain diluents or inert substances and surfactants

capsule suspensions and microcapsules

ultra-low-volume formulations.

The abovementioned formulation types are known to the person skilled in the art and described, for example, in: K. Martens, “Spray Drying Handbook”, 3rd Ed., G. Goodwin Ltd., London. 1979; W. van Valkenburg “Pesticide Formulations”, Marcel Dekker, N.Y. 1973; Winnaker-Küchler, “Chemische Technologie” [Chemical Technology], Volume 7, C. Hauser Verlag Munich, 4th Edition 1986; “Perry's Chemical Engineer's Handbook”, 5th Ed., McGraw-Hill, N.Y. 1973, pages 8-57.

The formulation auxiliaries required, such as inert materials, surfactants, solvents and further additives are also known and are described, for example, in: McCutcheon's “Detergents and Emulsifiers Annual”, MC Publ. Corp., Ridgewood N.J.; C. Marsden, “Solvents Guide”, 2nd Ed., Interscience, N.Y. 1963; H. von Olphen, “Introduction to Clay Colloid Chemistry”, 2nd Ed., J. Wiley & Sons, N.Y.; Schönfeldt, “Grenzflächenaktive Äthylenoxidaddukte” [Surface-Active Ethylene Oxide Adducts], Wiss. Verlagsgesellschaft, Stuttgart 1976; Sisley and Wood, “Encyclopedia of Surface Active Agents”, Chem. Publ. Co. Inc., N.Y. 1964; Watkins, “Handbook of Insecticide Dust Diluents and Carriers”, 2nd Ed., Darland Books, Caldwell N.J.; Winnacker-Küchler, “Chemische Technologie”, Volume 7, C. Hauser Verlag Munich, 4th Edition 1986.

In addition to the abovementioned formulation auxiliaries, the crop protection formulations compositions may comprise, if appropriate, customary tackifiers, wetting agents, dispersants, penetrants, emulsifiers, preservatives, antifreeze agents, fillers, carriers, colorants, anti-foams, evaporation inhibitors and pH and viscosity regulators.

Depending on the formulation type, the crop protection compositions generally comprise 0.1 to 99% by weight, in particular 0.2 to 95% by weight, of one or more safeners of the formula I or a combination of safener and pesticide. Furthermore, they comprise 1 to 99.9, in particular 4 to 99.5, % by weight of one or more solid or liquid additives and 0 to 25, in particular 0.1 to 25, % by weight of a surfactant. In emulsifiable concentrates, the active compound concentration, i.e. the concentration of safener and/or pesticide, is generally 1 to 90, in particular 5 to 80, % by weight. Dusts usually comprise 1 to 30, preferably 5 to 20, % by weight of active compound. In wettable powders, the active compound concentration is generally 10 to 90% by weight. In water-dispersible granules, the active compound content is, for example, between 1 and 95% by weight, preferably between 10 and 80% by weight.

For use, the formulations which are present in commercial form are, if appropriate, diluted in a customary manner, for example in the case of wettable powders, emulsifable concentrates, dispersions and water-dispersible granules with water. Dust preparations, granules and sprayable solutions are usually not diluted with any further inert substances prior to use. The required rate of application of the safeners varies with the external conditions such as, inter alia, temperature, humidity, and the kind of herbicide employed. The safeners (I) are usually formulated and then diluted to get a solution, dispersion, suspension or emulsion to be applied the purpose of the seed treatment. The other pesticides are usually formulated and in most cases then diluted with water for the purposed of providing a ready-to-use formulation or spray-formulation to be applied to the soil, plants or the area under cultivation.

The following non-limiting examples illustrate the invention wherein safener (Ia) is 5,5-diphenylisoxazoline-3-carboxylic acid and safener (Ib) is ethyl 5,5-diphenylisoxazoline-3-carboxylate.

### EXAMPLES

1.1 Seed Treatment

The number of crop seeds that would be needed for each safener rate was calculated. Based on the weight of 100 seeds, sufficient seeds were weighed into screw top glass bottles approximately twice the volume of the seeds.

The prospective safeners were formulated as wettable powders or water dispersible granules. These formulations were weighed out so that the required rates (g a.i./kg seed) would be obtained. The samples were added to the seeds in the bottles and then sufficient water added to produce a slurry. The bottles were capped and then placed in an overhead shaker (set at medium speed for up to 1 hour) so that the seeds were evenly coated with the slurry. The bottles were uncapped and the seeds used in the pre- or post-emergence tests as described in sections 1.2 and 1.3.

As an alternative seed treatment method, active ingredient of the prospective safeners was weighed and dissolved in a solvent (e.g. acetone) and added to the seeds in the bottles. The solvent type and volume was selected based on prior experience so that it would have no negative impact on seed germination or subsequent plant growth. After shaking for up to 1 hour (overhead shaker) the seeds were spread out on paper in a fume cabinet to allow the remaining solvent to evaporate. The seeds were then used in the pre- or post-emergence tests as described in sections 1.2 and 1.3.

In tests in which larger quantities of seeds required treatment, the prospective safeners, either as formulated samples in water or as active ingredient dissolved in solvent were applied to seeds using a mini-rotostat apparatus. The seeds were allowed to dry for a short time before being used in the pre- or post-emergence tests as described in sections 1.2 and 1.3.

1.2 Pre-emergence Herbicide Application

The safener treated seeds and untreated comparison seeds were sown into 7 to 13 cm round pots in a sandy loam soil and covered with approximately 0.5 to 1 cm of a 1 to 1 mix of sandy loam soil and sand. Herbicidal substances, as liquid (e.g. Emulsifiable concentrates) or dry (e.g. wettable powder) formulations, were diluted to the required concentrations in deionised water and applied to the soil surface using a track sprayer calibrated to deliver 300 to 800 litres of spray solution per hectare.

The pots were placed under good growing conditions in a glasshouse and a visual assessment of herbicidal effects made after 3 to 4 weeks after herbicide application. Assessment was on a percentage basis in comparison with untreated control plants (0%=no injury, 100%=complete kill).

1.3 Post-emergence Herbicide Application

The safener treated seeds and untreated comparison seeds were sown into 9 to 13 cm round pots in a sandy loam soil and covered with approximately 1 cm of a 1 to 1 mix of sandy loam soil and sand. The pots were placed under good growing conditions in a glasshouse for approximately 2-3 weeks, until the plants reached the 2 to 4 leaf stage. Herbicidal substances, as liquid (e.g. Emulsifiable concentrates) or dry (e.g. wettable powder) formulations, were diluted to the required concentrations in deionised water and applied to the green plant parts and intervening soil surface using a track sprayer calibrated to deliver 300 to 800 litres of spray solution per hectare.

The pots were returned under good growing conditions in a glasshouse and a visual assessment of herbicidal effects made at intervals from 1 to 4 weeks after herbicide application. Assessment was on a percentage basis in comparison with untreated control plants (0%=no injury, 100%=complete kill).

1.4 Pre-emergence Application with Herbicide After Seed Treatment

Corn seeds were treated according to example 1.1. After sowing the herbicide was applied pre-emergent on the soil surface as described in example 1.2. After 3 to 4 weeks the results were visually scored in comparison with control plants (without seed treatment and herbicide treatment). The results are summarised in Table 1 below.

TABLE 1

| | Dose | | | |
|---|---|---|---|---|
| Safener in | safener | Herbicide H1 | | Safener effect in |
| seed | [g a.i./kg | pre-emergent | % injury to | % reduction in |
| treatment | seed] | [g a.i./ha] | ZEAMA | crop injury |
| — | — | 100 | 35 | — |
| (la) | 0.5 | 100 | 15 | 57 |
| (lb) | 0.1 | 100 | 10 | 71 |

Abbreviations:
Herbicide H1 = isoxaflutole
Safener (la) = 5,5-diphenyl-2-isoxazoline-3-carboxylic acid
Safener (lb) = ethyl 5,5-diphenyl-2-isoxazoline-3-carboxylate
ZEAMA = Zea mays (maize), variety Lorenzo

1.5 Pre-emergence Application with Herbicide After Seed Treatment

Wheat or barley seeds were treated according to example 1.1. After sowing the herbicide was applied pre-emergent on the soil surface as described in example 1.2. After 3 to 4 weeks the results were visually scored in comparison with control plants (without seed treatment and herbicide treatment). The results are summarised in Tables 2 and 3 below.

TABLE 2

| | | | | Safener |
|---|---|---|---|---|
| Safener in | | Herbicide H2 | % | effect in |
| seed | Dose safener | pre-emergent | injury to | % reduction in |
| treatment | [g a.i./kg seed] | [g a.i./ha] | TRZAS | crop injury |
| — | — | 700 | 73 | — |
| (lb) | 2 | 700 | 15 | 79 |
| (lb) | 1 | 700 | 20 | 73 |
| (lb) | 0.5 | 700 | 10 | 86 |

TABLE 3

| | | | | Safener |
|---|---|---|---|---|
| Safener in | | Herbicide H2 | % | effect in |
| seed | Dose safener | pre-emergent | injury to | % reduction in |
| treatment | [g a.i./kg seed] | [g a.i./ha] | HORVS | crop injury |
| — | — | 700 | 15 | — |
| (lb) | 1 | 700 | 0 | 100 |
| (lb) | 0.5 | 700 | 0 | 100 |

Abbreviations in Tables 2 and 3:
Herbicide H2 = metolachlor
Safener (lb) = ethyl 5,5-diphenyl-2-isoxazoline-3-carboxylate
TRAZAS = Triticum aestivum (wheat), variety Ralle
HORVS = Hordeum vulgare (barley), variety Boroness

1.6 Post-emergence Application with Herbicide After Seed Treatment

Corn seeds were treated according to example 1.1. After sowing the corn was grown up to the 2 to 3-leaf stage. The herbicide was applied post-emergent as described in example 1.3. After 3 to 4 weeks the results were visually scored in comparison with control plants (without seed treatment and herbicide treatment). The results are summarised in Table 4 below.

TABLE 4

| | | Herbicide | | |
|---|---|---|---|---|
| Safener in | | H3 pre- | % injury to | Safener effect in |
| seed | Dose safener | emergent | corn | % reduction in |
| treatment | [g a.i./kg seed] | [g a.i./ha] | (variety Dea) | crop injury |
| — | — | 500 | 23 | — |
| (lb) | 0.01 | 500 | 10 | 57 |

Abbreviations in Table 4:
Herbicide H3 = herbical mixture of 21.4% by weight of sodium salt of diflufenzopyr and 55% by weight of sodium sald of dicamba
Safener (lb) = ethyl 5,5-diphenyl-2-isoxazoline-3-carboxylate

1. A method of protecting crop plants from phytotoxic side-effects of pesticides which comprises applying to the seed of a crop plant prior to sowing an effective amount of a compound of the formula (I) or a salt thereof, 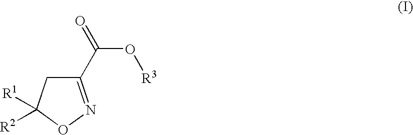
in which
R¹ is phenyl which is unsubstituted or substituted,
R² is (C₁-C₆)alkyl, (C₃-C₆)cycloalkyl or phenyl, each of the 3 last-mentioned radicals is unsubstituted or substituted,
R³ is hydrogen or a hydrocarbon radical having 1 to 18 C-atoms which is unsubstituted or substituted.

2. A method as claimed in claim 2 wherein in formula (I)
R¹ is phenyl which is unsubstituted or substituted by one or more radicals selected from the group consisting of halogen, cyano, nitro, amino, (C₁-C₄)haloalkyl, (C₁-C₄)haloalkoxy, (C₁-C₄)alkyl, (C₁-C₄)alkoxy, mono(C₁-C₄)alkyl-amino, di(C₁-C₄)alkyl-amino, (C₁-C₄)alkylthio and (C₁-C₄)alkylsulfonyl,
R² is (C₁-C₆)alkyl, (C₃-C₆)cycloalkyl or phenyl, each of the 3 last-mentioned radicals is unsubstituted or substituted by one or more radicals selected from the group consisting of halogen, cyano, nitro, amino, (C₁-C₄)haloalkyl, (C₁-C₄)haloalkoxy, (C₁-C₄)alkyl, (C₁-C₄)alkoxy, mono(C₁-C₄)alkyl-amino, di(C₁-C₄)alkyl-amino, (C₁-C₄)alkylthio and (C₁-C₄)alkylsulfonyl,
R³ is hydrogen or a hydrocarbon radical having 1 to 18 C-atoms which is unsubstituted or substituted by one or more radicals selected from the group consisting of
halogen, cyano, thio, nitro, hydroxyl, (C₁-C₆)alkyl, (C₁-C₆)haloalkyl, the 2 last-mentioned radicals as substituents of cyclic radicals only, (C₁-C₆)alkoxy, (C₂-C₆)alkenyloxy, (C₂-C₆)alkinyloxy, (C₁-C₆)haloalkoxy, (C₂-C₆)alkylthio, (C₃-C₆)cycloalkyl, (C₃-C₆)cycloalkoxy, (C₁-C₈)alkoxy-carbonyl, (C₂-C₆)alkenyloxy-carbonyl, (C₂-C₆)alkinyloxy-carbonyl, (C₁-C₈)alkyl-carbonyl, (C₁-C₆)alkyl-carbonyloxy, phenyl, phenyl-(C₁-C₆)alkoxy, phenyl-(C₁-C₆)alkoxy-carbonyl, phenoxy, phenoxy-(C₁-C₆)alkoxy, phenoxy-(C₁-C₆)alkoxy-carbonyl, phenoxycarbonyl, phenylcarbonyloxy and phenyl-(C₁-C₆)alkyl-carbonyloxy,
wherein the 9 last-mentioned radicals are unsubstituted or substituted in the phenyl ring by one or more radicals selected from the group consisting of halogen, (C₁-C₄)alkyl, (C₁-C₄)alkoxy, (C₁-C₄)haloalkyl, (C₁-C₄)haloalkoxy and nitro,
and radicals of the formula —O—N═CR′₂, —N═CR′₂,
wherein the R′ in the formulae independently of one another are hydrogen, (C₁-C₄)alkyl or phenyl, which is unsubstituted or substituted by one or more radicals selected from the group consisting of halogen, (C₁-C₄)alkyl, (C₁-C₄)alkoxy, (C₁-C₄)haloalkyl, (C₁-C₄)haloalkoxy and nitro, or together are a (C₂-C₆)alkylene chain.

3. A method as claimed in claim 1 or 3 wherein in formula (I)
R¹ and R² both are phenyl and R³ is hydrogen or (C₁-C₆)alkyl which is unsubstituted or substituted by one or more radicals selected from the group consisting of
halogen, cyano, (C₁-C₄)alkoxy, (C₂-C₄)alkenyloxy, (C₂-C₄)alkinyloxy, (C₁-C₄)haloalkoxy, (C₂-C₄)alkylthio, (C₃-C₆)cycloalkyl, (C₃-C₆)cycloalkoxy, (C₁-C₄)alkoxy-carbonyl, (C₂-C₄)alkenyloxy-carbonyl, (C₂-C₄)alkinyloxy-carbonyl, (C₁-C₄)alkyl-carbonyl, (C₁-C₄)alkyl-carbonyloxy and phenyl which is unsubstituted or substituted in the phenyl ring by one or more radicals selected from the group consisting of halogen, (C₁-C₄)alkyl, (C₁-C₄)alkoxy, (C₁-C₄)haloalkyl and (C₁-C₄)haloalkoxy.

4. A method as claimed in any of claims 1 to 3 wherein in formula (I) R³ is H or (C₁-C₄)alkyl.

5. A method as claimed in claim 1 wherein the safener of formula (I) is 5,5-diphenyl-2-isoxazoline-3-carboxylic acid.

6. A method as claimed in claim 1 wherein the safener of formula (I) is ethyl 5,5-diphenyl-2-isoxazoline-3-carboxylate.

7. A method as claimed in any of claims 1 to 5 wherein the seed treated with safener of formula (I) or salt thereof is seeded and a pesticide is applied to the crop area pre-emergent or post-emergent related to the crop.

8. A method as claimed in claim 7 wherein the seed treated with safener of formula (I) or salt thereof is seeded and one or more pesticides or pesticide combinations are applied to the crop area pre-emergent and/or post-emergent related to the crop.

9. A method as claimed in claim 7 or 8 wherein the pesticide is a herbicide selected from the group consisting of the carbamates, thiocarbamates, haloacetanilides, substituted phenoxy-, naphthoxy- and phenoxyphenoxy carboxylic acid derivatives and heteroaryloxyphenoxyalkane carboxylic acid derivatives, such as quinolyloxy-, quinoxalyloxy-, pyridyloxy-, benzoxazolyloxy- and benzothiazolyloxyphenoxyalkane carboxylic acid esters, cyclohexanedione derivatives, imidazolinones, pyrimidinyloxypyridincarboxylic acid derivatives, pyrimidyloxybenzoic acid derivatives, sulfonylureas, triazolopyrimidinesulfonamide derivatives and S-(N-aryl-N-alkylcarbamoylmethyl)dithiophosphoric esters, hormone-type herbicides, pyridinecarboxylic acids, triazinones, triazolinones, pyridinecarboxamides, hydroxybenzonitriles and isoxazoles.

10. A method as claimed in any of claims 7 to 9 wherein the crop is maize.

11. A method as claimed in any of claims 7 to 10 wherein the application rate of safener is from 0.01 to 10 grammes a. i. safener per kilogramme seed.

12. A method of combatting undesired organisms in a crop of useful plants wherein the seed of the crop plants is treated prior to sowing with an effective amount of a compound of the formula (I) or a salt thereof as defined in any of claims 1 to 6 and, after sowing, one or more pesticides or pesticide combinations are applied to the crop plants or the area under cultivation pre-emergent and/or post-emergent related to the crop.

13. A method of as claimed in claim 12, wherein the pesticide is a herbicide for combatting weeds in a crop of useful plants.

14. A method of as claimed in claim 12 or 13, wherein the crop is maize.

15. A method as claimed in any of claims 12 to 14 wherein the application rate of safener is from 0.01 to 10 grammes a. i. safener per kilogramme seed.

16. A method as claimed in any of claims 12 to 15 wherein a herbicide selected from the group consisting of the isoxazoles is applied pre-emergent to the crop area, optionally followed by another herbicide or herbicide combination applied post-emergent related to the crop.
